(19) United States
(12) Patent Application Publication
(10) Pub. No.: US 2026/0220148 A1
(43) Pub. Date: Jul. 30, 2026

(54) ENHANCED FIDELITY SYSTEMS AND METHODS FOR DIGITAL PORTAL DATA REFINEMENT

(71) Applicant: BOLD Limited, Hamilton (BM)

(72) Inventors: Rahul BINDLISH, Noida (IN); Artun KOROGLUYAN, San Francisco, CA (US); Kip DAYNARD, Huntsville (CA); Baroon ANAND, New Delhi (IN)

(21) Appl. No.: 19/041,893

(22) Filed: Jan. 30, 2025

(51) Int. Cl. G06F 16/25; G06F 16/2455

(52) U.S. Cl. CPC G06F 16/254; G06F 16/2456

(57) ABSTRACT

Certain aspects of the disclosure provide systems and methods for comprehensive processing of diverse digital portal data. Certain aspects include receiving raw data of one or more target digital portals comprising raw clickstream data and raw real-time streaming data; extracting, utilizing a connection with one or more back end databases associated the one or more target digital portals, transactional data of the one or more target digital portals; converting the raw real-time streaming data to reformatted real-time streaming data; executing an extract, load, transform (ELT) pipeline to convert the stored raw clickstream data into transformed data; generating cube files corresponding to respective events within the received raw clickstream data; receiving, from a user of a front-end application, a query; generating results corresponding to the query based on one or more of the cube files, the reformatted real-time streaming data, and the transformed data.

### INTRODUCTION

### Technical Field

The present specification relates to enhanced fidelity systems and methods for comprehensive ingestion and refinement of diverse digital portal data.

### Background

As organizations scale, the challenge of efficiently processing high volumes of digital portal data becomes increasingly difficult. A digital portal may include a website, an application, or any other accessible online platform. Digital portal data may refer to any information generated, collected, and utilized within a digital portal. For example, digital portal data may include, but is not limited to, data associated with user interactions, content delivery, service access, and logs. Processing digital portal data typically involves utilizing robust and scalable systems equipped to handle high volumes of digital portal data. Data refinement may be used to improve raw or unstructured data to make it more accurate, reliable, and usable for performing downstream analysis and decision-making. The processed data may then be leveraged to provide various real-time or historical insights and end uses, for example, via querying. Quick access to processed digital portal data enhances analytical capabilities, improving an organization's data-driven decision-making capability and providing a competitive advantage in the digital landscape. Consequently, there is a need to further improve systems and methods for processing digital portal data.

### SUMMARY

Certain aspects provide a method including: receiving, from one or more target digital portals, raw data of the one or more target digital portals comprising raw clickstream data and raw real-time streaming data; extracting, utilizing a connection with one or more back end databases associated the one or more target digital portals, transactional data corresponding to events of the one or more target digital portals; storing the raw clickstream data in one or more storage components; sending the raw real-time streaming data to a set of components configured to convert the raw real-time streaming data to reformatted real-time streaming data; executing an extract, load, transform (ELT) pipeline to convert the stored raw clickstream data into transformed data; storing the transformed data into one or more schemas; generating, using a semantic layer, cube files corresponding to respective events within the received raw clickstream data; receiving, from a user of a front-end application, a query corresponding to a requested action; generating, using the semantic layer and one or more of the cube files, an improved query comprising a structured query language (SQL) query; generating results for the improved query based on one or more of the reformatted real-time streaming data and the transformed data; and outputting the generated results to the user of the front-end application.

Other aspects provide a method including: receiving, from one or more target digital portals, raw data of the one or more target digital portals comprising raw clickstream data and raw real-time streaming data; extracting, utilizing a connection with one or more back end databases associated the one or more target digital portals, transactional data corresponding to events of the one or more target digital portals; storing the raw clickstream data in one or more storage components; sending the raw real-time streaming data to a set of components configured to convert the raw real-time streaming data to reformatted real-time streaming data; executing an extract, load, transform (ELT) pipeline to convert the stored raw clickstream data into transformed data; storing the transformed data into one or more schemas; and generating, using a semantic layer, cube files corresponding to respective events within the received raw clickstream data.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an illustrative environment for implementing a data processing system according to one or more aspects.

FIG. 2 depicts an illustrative layered architecture of a data processing system according to one or more aspects.

FIG. 3 depicts an illustrative process implemented by a staging layer of a data processing system to extract and receive data of one or more digital portals according to one or more aspects.

FIG. 4 depicts an illustrative process implemented by a data processing system for processing clickstream data according to one or more aspects.

FIG. 5 depicts an illustrative process implemented by a data processing system for processing real-time streaming data according to one or more aspects.

FIG. 6 depicts an illustrative process implemented by a semantic layer of a data processing system according to one or more aspects.

FIG. 7 depicts an illustrative cube file generated by a semantic layer of a data processing system according to one or more aspects.

FIG. 8 depicts an illustrative process implemented by an application layer of a data processing system according to one or more aspects.

FIG. 9 depicts an illustrative process implemented by an application layer of a data processing system according to one or more aspects.

FIG. 10 depicts an illustrative process implemented by a data processing system for performing bulk exporting of processed digital portal data according to one or more aspects.

FIG. 11 depicts a flowchart of a method for processing diverse digital portal data using a data processing system according to one or more aspects.

FIG. 12 schematically depicts an illustrative computing device configured to perform processes of the data processing system, according to one or more aspects.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and computer-readable mediums for comprehensive processing of diverse digital portal data. Aspects described herein leverage specially programmed processing device(s) to ingest and process diverse digital portal data, including data having different types. Aspects described herein further utilize a system architecture including improved staging layers for receiving certain digital portal data via a direct connection between one or more back end databases associated with one or more digital portals. The system architecture including the improved staging layer further allows for more control over data governance, data security, and data management, allowing for ingestion and processing of more comprehensive digital portal datasets.

As previously discussed, digital portal data refers to information generated, collected, and utilized within a digital portal to facilitate user interactions, content delivery, and service access. A digital portal may include a website, an application, or any other accessible online platform. Digital portal data may encompass a wide range of information types and can be derived from various activities and system processes. For example, digital portal data may include clickstream data related to user interactions such as user clicks, page views, and navigation paths through the portal. Digital portal data may further include transactional data related to transactions conducted within the portal such as purchases, registrations, and subscriptions. Digital portal data may also include real-time streaming data related to continuously received, event-driven data for immediate processing including user interactions and system events. Various additional types of digital portal data (e.g. user-generated content data, demographic and profile data, metadata, system performance data, behavioral data, feedback and survey data, etc.) may further be collected and processed, further contributing to the challenge of efficiently processing high volumes of digital portal data as the amount of available digital portal data increases Aspects described herein are further configured to process ingested data using certain components based on a type of the received digital portal data. Aspects described herein further allow a user to leverage the processed digital portal data for a variety of end uses via an application such as a browser.

Conventional systems and techniques for processing digital portal data often involve utilizing a third-party web-based platform to handle transport, ingestion, and processing of digital portal data associated with one or more digital portals. Sending and tracking digital portal data using conventional systems and techniques involves employing an increased number of tracking scripts and HyperText Transfer Protocol (HTTP) network calls to and from a given third-party web-based platform for each tracked event or record from the digital portal. Sending increased numbers of tracking scripts and HTTP network calls to and from the third-party web-based platform can cause unwanted latency, slowing down user interactions on the digital portal. The event-based data transport mechanisms relied upon by conventional systems and techniques further suffer from imperfect fidelity with back end transactional data of a given digital portal. Since third-party web-based platforms are unable to access any digital portal data directly, all digital portal data must be sent or transferred using data transport mechanisms that introduce risk of data loss. For example, convention systems may utilize discrete, event-based data transport mechanisms (e.g. HTTP) to enable the third-party web-based platform to ingest and process real-time streaming. HTTP transport mechanisms are designed around a request-response model, where a user sends a request to a server and waits for a response. Accordingly, ingesting and processing real-time streaming is inherently difficult using HTTP transport mechanisms, causing undesirable loss of various data (e.g. event data, transaction data, session data, etc.) if a user's connection drops during data ingestion and processing. Conventional systems and techniques for processing digital portal data are further limited by their inability to ingest and process certain types of data that are not suitable for sharing via transport mechanisms described above. As an example, certain internal back end data from a connected digital portal typically includes sensitive, private, or regulated data that may not practically be shared outside of the company using HTTP network calls as they may include private data subject to regulatory frameworks, or proprietary information that an organization wishes to maintain internally. Accordingly, conventional systems and techniques for processing digital portal data that leverage third-party web-based platforms generally do not include valuable internal back end data, causing decreased accuracy in downstream tasks that rely upon leveraging processed digital portal data. Convention systems and techniques also burden organizations and users with reduced control over how ingested data is processed and utilized for downstream tasks. As an example, an organization relying on convention systems and techniques may send digital portal data to a third-party web-based platform, removing the control of how the data is processed and how it may be used for downstream tasks from the organization that owns and runs the digital portal.

In contrast, aspects described herein provide a technical solution to the described shortcoming of conventional techniques by utilizing novel system architecture including improved staging layers configured to ingest (for subsequent processing) diverse digital portal data in a more efficient and comprehensive manner. For example, aspects described herein include the system architecture including a staging layer configured to utilize direct connections with back end databases associated with one or more digital portal, enabling aspects herein to ingest and process digital portal data with improved fidelity and reduced data loss as compared to the transport mechanisms relied upon by conventional methods for transporting digital portal data. Described aspects further utilize the system architecture configured to ingest and process diverse digital portal data including real-time streaming data and clickstream data with reduced numbers of HTTP network calls, as described aspects do not utilize further HTTP network calls for sending the digital portal data to a third-party web-based platform relied upon by conventional techniques. Described aspects then funnel the data, depending on a data type, to different components for real-time processing or batch mode processing. By utilizing a system architecture that eliminates reliance on third-party web-based platforms, described aspects allow organizations employing described aspects to have improved control over data governance and security of the ingested and processed data. Additional control and security over digital portal allows organizations to utilize additional data associated with one or more digital portals that are otherwise unusable when relying upon conventional techniques that transport digital portal data to third-party web-based platforms. As an example, described aspects include a layered architecture including components configured to join processed clickstream data with relevant business intelligence tables including internal back end data that would otherwise be unusable using conventional techniques due to one or more of the data security concerns listed above. Described aspects include a system architecture that further provides organizations with increased control and understanding of how data is processed and how it may be used for downstream tasks. As an example, described aspects include a system architecture for ingesting and processing real-time streaming of a digital portal using a first set of components, and clickstream data of the digital portal using a second set of components, providing organizations with transparency and control over the digital portal data being processed. Described aspects further include a system architecture including an application layer providing increased customizability in leveraging of the processed digital portal data. For example, described aspects include an application layer configured to allow users to create custom events and custom properties for utilizing digital portal data that may be used to further enhance existing insight and reporting functionalities of the application layer.

Described aspects for comprehensive processing of digital portal data further provide technical benefits. For example, described aspects utilize a system architecture for digital portal data ingestion that eliminate reliance on third-party web-based platforms, requiring fewer HTTP network calls, which improves web performance (e.g. quick page load times, fewer outgoing tracking calls, etc.) for users interacting with the digital portals. Fewer HTTP network calls also causes described aspects to provide the technical benefit of improved accuracy in the transporting of event data, due to reduced loss of event data during data transport. Reduced loss of event data provides an additional technical benefit of improved accuracy when performing downstream tasks that rely upon the digital portal data ingested and processed by aspects described herein. Described aspects further provide for improved fidelity due to integration of the system architecture with one or more back end databases associated with one or more digital portals. The integration of the system architecture of described aspects with back end databases provides the technical benefit of improved accuracy in downstream tasks and end uses that benefit from leveraging a more complete and comprehensive dataset unaffected by loss of digital portal data due to employing faulty transport mechanisms associated with conventional techniques. Described aspects further improve accuracy and precision in performance of downstream tasks by ingesting and processing internal back end data to store more comprehensive digital portal datasets including sensitive or proprietary digital portal data. Typically, internal back end data is unusable using conventional techniques due to security or privacy concerns (alleviated due to the native system architecture including a staging layer that gives users of described aspects improved control over data governance and data security.) Described aspects further provide a system architecture including an application layer that allows organizations and users to create custom events and properties for processed digital portal data. Allowing users to create custom events and properties provides the technical benefit of enabling the application layer to provide enhanced functionality in response to user modifications to basic properties and functions of certain tools or components within the application layer.

### Example Data Processing System for Comprehensive Processing of Diverse Digital Portal Data

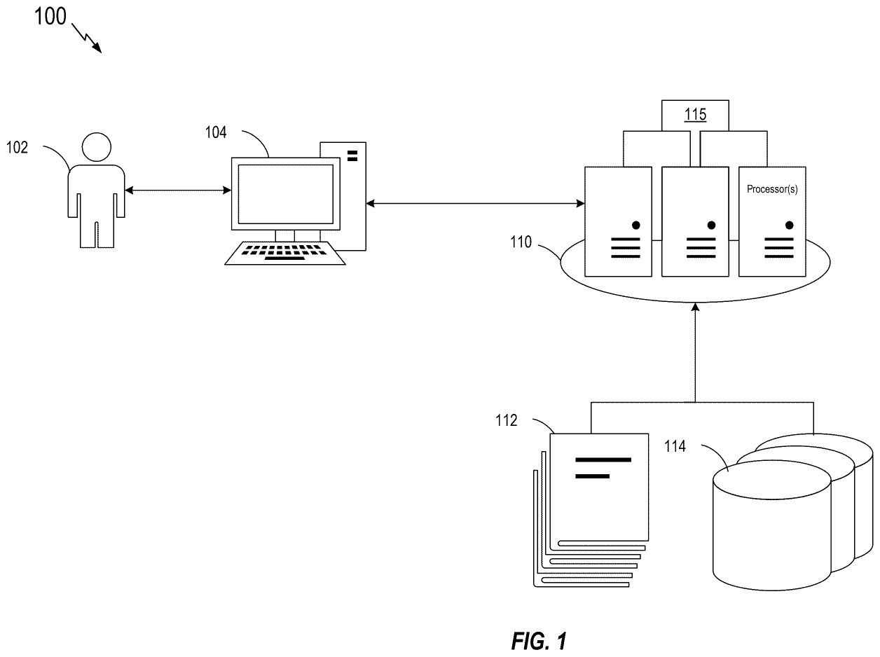

FIG. 1 depicts an illustrative environment 100 for implementing a data processing system 110 configured to perform techniques for processing digital portal data according to one or more aspects. The data processing system 110 may be configured to interface with a user 102 via a user device 104. User 102 may interface with aspects of the data processing system 110, for example implemented by one or more processors, through the user device 104 to perform a variety of functions described herein. For example, in certain aspects, user 102 may interface with an application of data processing system 110 through user device 104 to input queries or requests related to data analytics or reporting functionalities associated with the back end digital portal data processed by data processing system 110. As an example, a user may interface with an application of data processing system 110 to request generation of a retention report to assess user engagement with the digital portal. In another example, a user may interface with an application of data processing system 110 to request bulk export of a set of processed data.

Data processing system 110 may include one or more computing devices 115 including one or more processor(s) and one or more non-transitory computer-readable mediums storing computer readable instructions that, when executed by the one or more processors, cause the computing device to perform processes defined by computer-readable instructions corresponding to one or more components depicted and described herein. Data processing system 110 may be configured to receive digital portal data from a back end of one or more digital portals 112 and one or more back end databases 114.

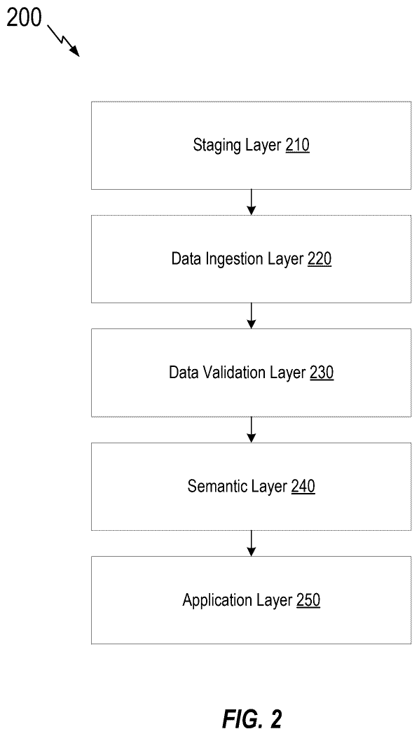

FIG. 2 depicts an illustrative layered architecture 200 of a data processing system according to one or more aspects. As used herein a “layer” refers to a group of components or architectural features for performing a similar or related task. Illustrative layered architecture includes a staging layer 210 for receiving and extracting digital portal data, a data ingestion layer 220 for ingesting and processing received or extracted digital portal data, a data validation layer 230 for monitoring quality of digital portal data, a semantic layer 240 for generating cube files and building queries, and an application layer 250 for allowing an organization or user to leverage the processed digital portal data for performing data analytics tasks. Illustrative layered architecture 200 and associated components are described in greater detail below in connection with illustrative processes performable by data processing systems in accordance with one or more aspects.

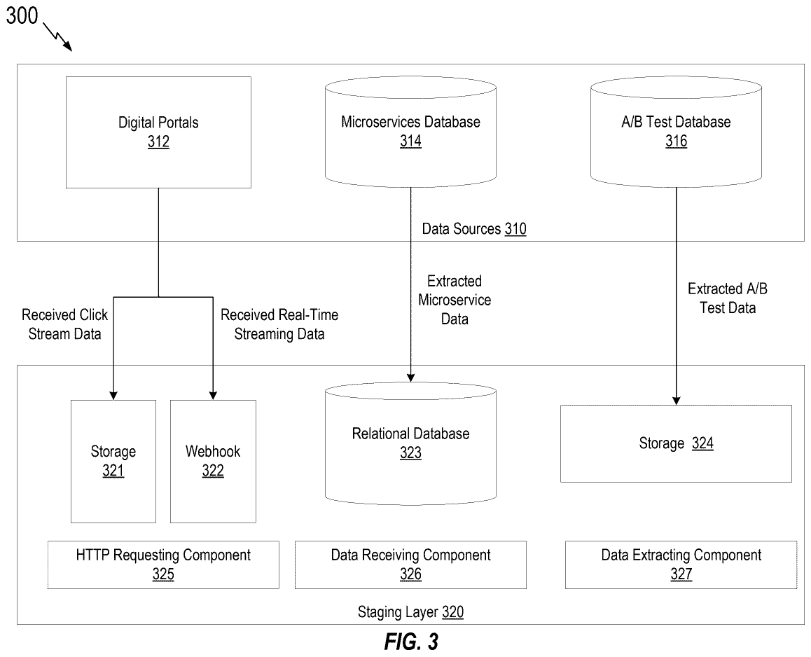

FIG. 3 depicts an illustrative process 300 performable by a staging layer (such as staging layer 210 of FIG. 2) of a data processing system according to one or more aspects. As shown, a staging layer 320 receives or extracts digital portal data from one or more data sources 310. In certain aspects, data sources 310 include one or more digital portals 312, one or more microservices databases 314, and A/B test database 316. As previously discussed, aspects described herein are configured to ingest and process diverse data of different data types from one or more digital portals, such as digital portals 312. While illustrative process 300 depicts certain features or components for ingesting and processing certain types of data associated with one or more digital portals 312, it may be understood that in some aspects, additional features may be included for enabling ingestion and processing of additional data types associated with data of the one or more digital portals 312.

In certain aspects, staging layer 320 is configured to receive different types of digital portal data from the one or more digital portals 312. As an example, staging layer 320 may be configured to receive, from the one or more digital portal 312, clickstream data. As used herein, “clickstream data” may refer to sequences performed by a user while navigating a connected digital portal, such as clicking a button, viewing a page, submitting a form, or other actions performable by the user within the digital portal. In certain aspects, an HTTP requesting component 325 of staging layer 320 sends an HTTP request to cause digital portal 312 to send clickstream data to a data receiving component 326 of staging layer 320. Staging layer 320 may be configured to temporarily store received clickstream data within storage 321. In certain aspects, storage 321 may be any suitable (local or accessible cloud-based) object storage component for storing data as individual objects (rather than files or blocks).

Staging layer 320 may further receive, from the one or more digital portals 312, real-time streaming data. Staging layer 320 may be configured to utilize a webhook 322 for automatic transmission of real-time streaming data from a connected digital portal to a set of components (sometimes referred to herein as a real-time ecosystem) for processing the raw real-time streaming data. As used herein, “real-time streaming data” refers to digital portal data continuously captured by the one or more digital portals 312 that is associated with user actions, logs, or network traffic that is to be immediately ingested and processed for real-time or short term downstream tasks performable by described systems and methods. For example, when an event occurs at the one or more digital portals (e.g. user clicking on a link, a user completing a transaction, creation of system log entries, etc.) webhook 322 continuously captures the raw real-time streaming data corresponding to the event. It may be appreciated that both the received clickstream data and the received real-time streaming data are in a “raw” format, as they are received in their original, unprocessed, and unrefined form.

Staging layer 320 is further shown extracting data from one or more microservices databases 314. As previously discussed, aspects described herein leverage a system architecture that utilizes direct connections between one or more back end databases associated with certain transactional data of one or more digital portals. As an example, staging layer 320 may be connected to a back end of a microservices database 314, such that the architecture and components of data processing systems described herein may access and utilize the stored microservices data. As used herein, “microservices” refer to independent services configured to perform specific functions that, when combined, build larger functionality for the digital portal. As an example, microservices may include user authentication services (e.g. verifying user identities, managing log in and log out functions, providing secure access, etc.) or user profile management services (e.g. user preferences, histories, settings, etc.) In certain embodiments, each microservice of a digital portal may manage its own data independently of other microservices, storing the data within a dedicated microservice database 314. Often, the stored microservice data is in a structured or semi-structured format. Accordingly, a data extracting component 327 of staging layer 320 is configured to extract data directly from the one or more microservice databases 314, and store the extracted data within a structured tables 323 (rows and columns) to facilitate manage, retrieval, and querying of the stored data. Described aspects thus ingest and process transactional data with improved fidelity by utilizing direct backend connections with databases associated with a target digital portal, improving accuracy, completeness, and reliability of extracted and stored digital portal data.

Staging layer 320 may further be configured to utilize a second direct connection between staging layer 320 and a back end A/B test database 316 to extract and store A/B test data within a storage 324. As used herein, A/B test data refers to data for evaluating user behaviors with respect to how the users interact with a first (“A”) and as second (“B”) version of certain web pages associated with the connected digital portal. The A/B test data may be semi-structured data combining structured data (e.g. numbers, dates, and metrics) with unstructured data (e.g. user interactions, logs, or comments). As with the previously described microservice database, staging layer 320 is able to utilize a direct connection with the A/B test database to extract additional data associated with the one or more digital portals 312 while minimizing the volume of HTTP network calls and resulting data loss.

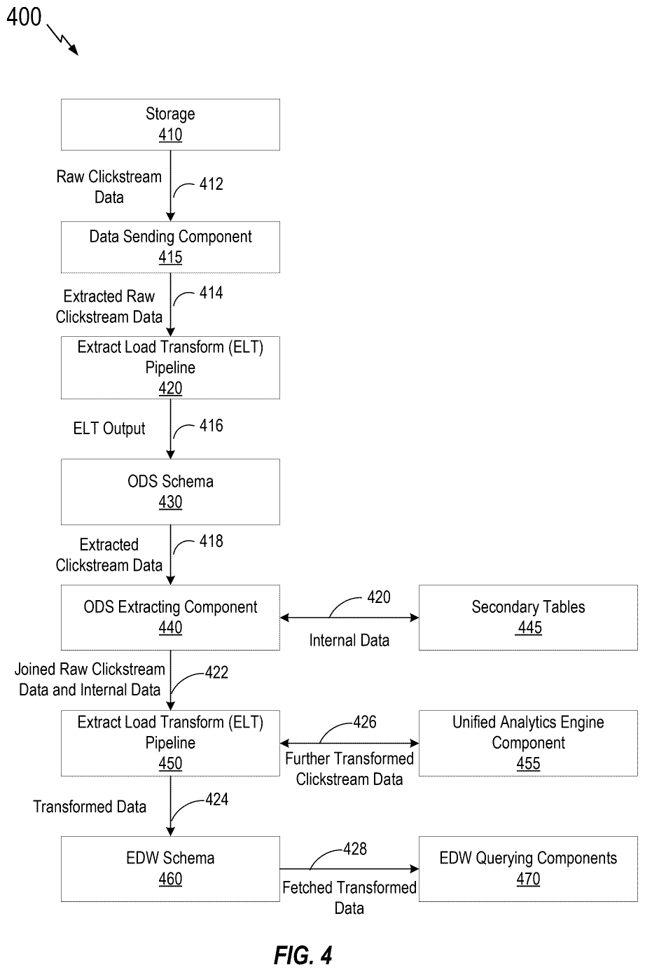

FIG. 4 depicts an illustrative process 400 performable by a data ingestion layer (such as data ingestion layer 220 of FIG. 2) of a data processing system to process raw clickstream data according to one or more aspects. More specifically, illustrative process 400 depicts how aspects described herein may process stored raw clickstream data for enabling downstream tasks and querying. In certain aspects, the data ingestion layer may be configured to process the raw clickstream data in a batch mode to enable downstream querying and insight discovery related to obtaining user behavior insights, user path insights, conversion tracking, and other information obtainable by leveraging the processed raw clickstream data. As used herein a “batch mode” refers to any suitable automated processing by described systems for high volumes of clickstream data that are stored for performing downstream tasks and analysis the clickstream data over a period of time (rather than for performing short-term or real-time analysis as the clickstream data is captured from one or more digital portals.) For example, the clickstream data ingested from the one or more digital portals using a batch mode may be stored for weeks, months, or even years before being utilized for downstream tasks for providing insights and analysis about the clickstream data over a period of time.

Illustrative process 400 starts with the received raw clickstream data from the one or more digital portals temporarily stored within one or more storage components, such as storage 410. As previously discussed, the received raw clickstream data may be temporarily stored within storage 410 or any suitable (local or accessible cloud-based) object storage component for storing data as individual objects (rather than files or blocks.) At 412, a data sending component 415 may then extract the raw clickstream data from the storage 410.

At 414, data sending component 415 sends the extracted raw clickstream data to an extract load transform (ELT) pipeline 420. At 416, the ELT pipeline 420 is configured to receive the raw clickstream data from the data sending component 415, transform the data (e.g. by cleansing, validating, and standardizing the data,) and store the ELT output, including the clickstream data, within an ODS schema 430.

Illustrative process 400 proceeds at 418 with an ODS extracting component 440 extracting the clickstream data from the ODS schemas. At 422, the extracted clickstream data is joined with data from secondary tables 445. Secondary tables 445 are tables related to the digital portals which include internal data of an organization or entity hosting the digital portal. As used herein, “internal data” refers to any sensitive or private data associated with a given digital portal. As an example, internal data may include user's personal information, user authentication data, proprietary business data, certain user behavioral data, or any other information a given business entity may wish to process and store separately from other digital portal data. In some examples, described aspects use secondary tables 445 to enrich extracted clickstream data with important attributes related to a given device, geography information, operating system information, browser details, and other useful attributes useful for performing downstream analysis of data associated with one or more digital portals. As previously discussed, aspects described herein utilize native system architecture that eliminates reliance on third-party web-based platforms. By utilizing native system architecture to handle all transport and processing of the digital portal data, organizations employing described aspects have improved control over data governance and security of the ingested and processed digital portal data. Accordingly, described aspects enable organizations to have the requisite security and control to leverage internal data associated with a digital portal. Incorporating internal data (for example, from the secondary tables 445) associated with a digital portal creates more comprehensive collections of digital portal data that provide the technical benefit of improved accuracy and precision in performing downstream tasks that rely upon the processed digital portal data.

At 422, the raw clickstream data (now including the added internal data where applicable) is sent to a second ELT pipeline 450 that is used to convert the raw clickstream data to transformed data by applying transformational logic, and then load the transformed data into an enterprise data warehouse (EDW) schema 460 at 424. In certain aspects, second ELT pipeline 450 may apply transformational logic for data cleansing (e.g. removing duplicates, null values, inconsistencies, etc.), data normalization (e.g. standardizing formats), data aggregation (e.g. summary tables for faster access), data enrichment, or other suitable transformations as may be useful for transforming the raw clickstream data into transformed data suitable for querying. Described aspects may further perform steps of illustrative process 400, as described above, to extract and store transactional data (such as transactional data stored within structured tables 323 described above with reference to FIG. 3) within EDW schema 460. This enables described aspects to further leverage the transactional data extracted directly from microservice databases of a given digital portal for downstream tasks.

In certain aspects, at 426, the second ELT pipeline 450 of the data ingestion layer (such as data ingestion layer 220 of FIG. 2) further sends the raw clickstream data from the one or more storage components, such as storage 410, to any suitable unified analytics engine component 455 for transforming the raw clickstream data using batch processing techniques. A “unified analytics engine component” refers to any suitable data processing framework designed to handle large-scale data for a variety of tasks, such as batch processing and SQL-based analytics in a single platform. In certain aspects, the unified analytics engine component 455 may be configured to perform further data transformations on the raw clickstream data, such as partitioning the raw clickstream data in the one or more storage components into a series of partitions, flattening schemas corresponding to respective events within the raw clickstream data, standardizing column names of the flattened schemas by removing irregularities within the column names, populating a series of relevant attributes associated with the respective events, and creating meta files for the respective events. The unified analytics engine component 455 thus enables effective scaling of data processing capabilities while further providing the technical benefit of improved management of computing resources for handling increased data volumes.

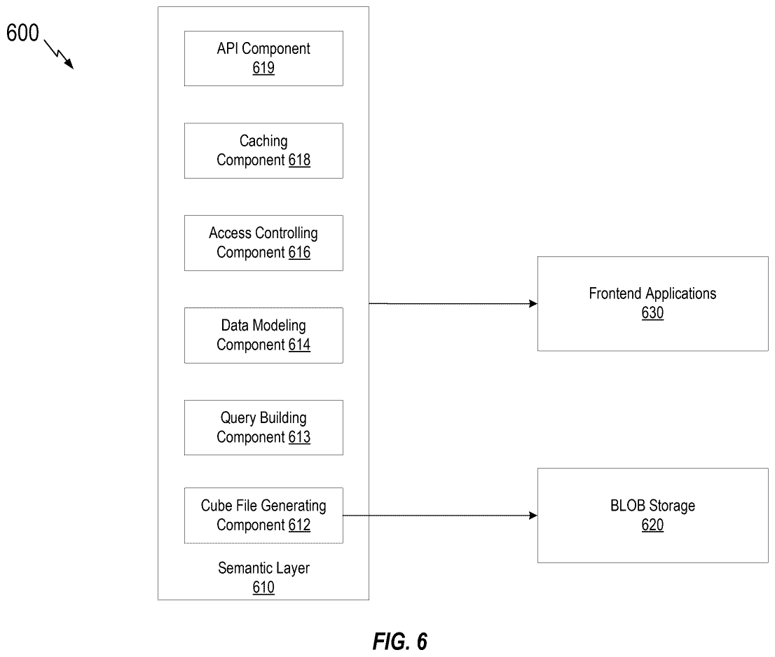

Once the transformed data is stored within EDW schemas 460, it may be fetched by an EDW querying component 470 to process queries received based on a user request from a front end application (such as via application layer 250 of FIG. 2.) Accordingly, at 428, the EDW querying component 470 may fetch transformed data from the EDW schemas 460 to process a given received query associated with a user request. In certain aspects, API components (such as API component 619 of FIG. 6) may be used to make an API call to utilize EDW querying components 470 for generating query results for a query built by a query building component (such as query building component 613 of semantic layer 610 depicted in FIG. 6) of the data processing system according to one or more aspects.

In aspects, after the clickstream data is processed by the data ingestion layer (such as data ingestion layer 220 of FIG. 2,) the data processing system is configured to utilize the data validation layer (such as data validation layer 230 of FIG. 2) to continuously monitor the quality of the data stored in the EDW schema (such as EDW schema 460 of FIG. 4.) The data validation layer may be configured to monitor the stored digital portal data, for example, by checking the data for missing fields, formatting and logical relationship inconsistencies, outdated or delayed data, inaccuracies, violations of schema validation rules, or performing any other suitable known steps for monitoring and maintaining the quality of the data stored within the EDW schema. When schema evolution occurs (e.g. adding columns for new events received from the one or more digital portals), the data validation layer 230 may be configured to utilize a control table to manage the state and execution flow of individual ETL jobs, and a master table to maintain an overall schedule, configuration, or orchestration logic for various ETL jobs associated with newly received digital portal data corresponding to one or more events.

By reading raw clickstream data from storage 410, described aspects avoid utilizing web-based scripts for transporting the raw clickstream data. This allows for described aspects to reduce the volume of HTTP requests to transport digital portal data, leading to improved precision and accuracy in downstream tasks, as well as improved web performance (e.g. quick page load times, fewer outgoing tracking calls, etc.) for users interacting with the digital portals. Described aspects further provide the technical benefit of reduced data loss when ingesting and processing the raw clickstream data, since reading raw clickstream has increased reliability compared to using web-based scripts.

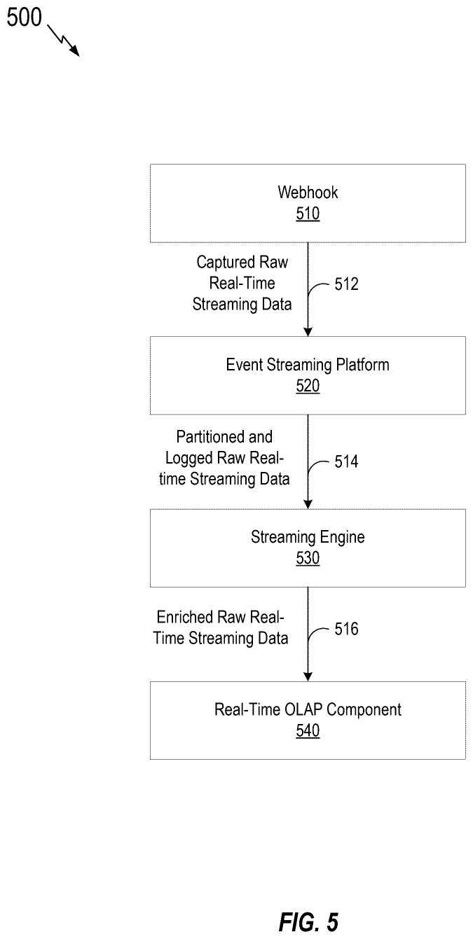

FIG. 5 depicts an illustrative process 500 performable by a data ingestion layer (such as data ingestion layer 220 of FIG. 2) of a data processing system to process raw real-time streaming data according to one or more aspects. Illustrative process 500 enables data processing systems according to one or more aspects to send raw real-time streaming data from the one or more digital portals to a set of components configured to convert the raw real-time streaming data to reformatted real-time streaming data. The set of components for processing and reformatting the real-time streaming data, such as a webhook 510, an event streaming platform 520, a streaming engine 530, and a real-time online analytical processing (OLAP) component 540 are described below in connection with illustrative process 500.

First, a webhook 510, of the data ingestion layer according to aspects herein, serves as a bridge between the one or more digital portals (such as the one or more digital portals 312 of FIG. 3) and an event streaming platform 520. For example, at 512, as events occurs at the one or more digital portals (e.g. user clicking on a link, a user completing a transaction, creation of system log entries, etc.) the webhook 510 is triggered to continuously capture and sends the raw real-time streaming data corresponding to the event to event streaming platform 520 for real-time processing.

In certain aspects, event streaming platform 520 is a distributed event streaming platform configured for processing and storing the raw real-time streaming data from the one or more digital portals. Event streaming platform 520 may be configured to store the raw real-time streaming data for each event into topic partitions with a unique offset for a predetermined retention period. The unique offset functions as a numerical identifier representing a position of certain data within the topic partitions. In certain aspects, event streaming platform 520 is configured to store raw real-time streaming data for events in ordered immutable logs. At 514, the event streaming platform 520 sends the partitioned and logged real-time streaming data to a streaming engine 530 integrated with event streaming platform 520.

Streaming engine 530 is configured to process, transform, and enrich the raw real-time streaming data for events from the one or more digital portals to facilitate performance of downstream insight and analytics tasks. As an example, streaming engine 530 may be configured to enrich the real-time streaming data by combining such event data with other data sources (e.g. databases, APIs, etc.) to enrich the events with additional context related to various user features (e.g. demographics or product data). As another example, streaming engine 530 may normalize the raw real-time streaming data employing formatting timestamps, filtering out irrelevant fields, etc. In certain aspects, streaming engine 530 may be configured to perform other functions, including but not limited to data aggregation, filtering and routing, and event-time processing.

At 516, the streaming engine 530 sends the raw real-time streaming data (enriched by the streaming engine 530) to a real-time OLAP component 540. In certain aspects, real-time OLAP component 540 is a distributed, real-time OLAP data store for performing low-latency (e.g. millisecond) operations and queries for larger-scale event streams, enabling high throughput data ingestion and downstream query execution. Real-time OLAP component 540 is configured to ingest the raw real-time streaming data, convert the ingested real-time streaming data into a columnar format, index the reformatted real-time streaming data, and store the indexed reformatted real-time streaming data for performing effective high-speed querying and aggregation for a variety of downstream tasks.

It may be appreciated that aspects described herein thus utilize an architecture configured to perform comprehensive processing of diverse digital portal data. For example, described aspects enable processing of continuously captured real-time streaming data for high-speed querying using a real-time OLAP component 540, for example, using illustrative process 500. Described aspects can further process clickstream data intended for longer term storage to enable querying of data stored within EDW schemas, for example, using illustrative process 400. As previously described, the native system architecture utilized by described aspects allows organizations to utilize additional sensitive or proprietary data that conventional techniques are unable to utilize due to regulatory, security, or privacy concerns. This provides the technical benefit of increased accuracy in downstream tasks based on utilizing more comprehensive digital datasets unaffected by data loss associated with conventional techniques. FIG. 6 depicts an illustrative process 600 that may be implemented by a semantic layer 610 of a data processing system in accordance with certain aspects herein. In certain aspects, semantic layer 610 abstracts raw data and presents it in a meaningful way to the end user, serving as a contextual filter between the data warehouse (such as EDW schemas 460 of FIG. 4) and the various end uses performed by the application layer (such as application layer 250 of FIG. 2). In certain aspects, semantic layer 610 corresponds to an open source cube.js framework.

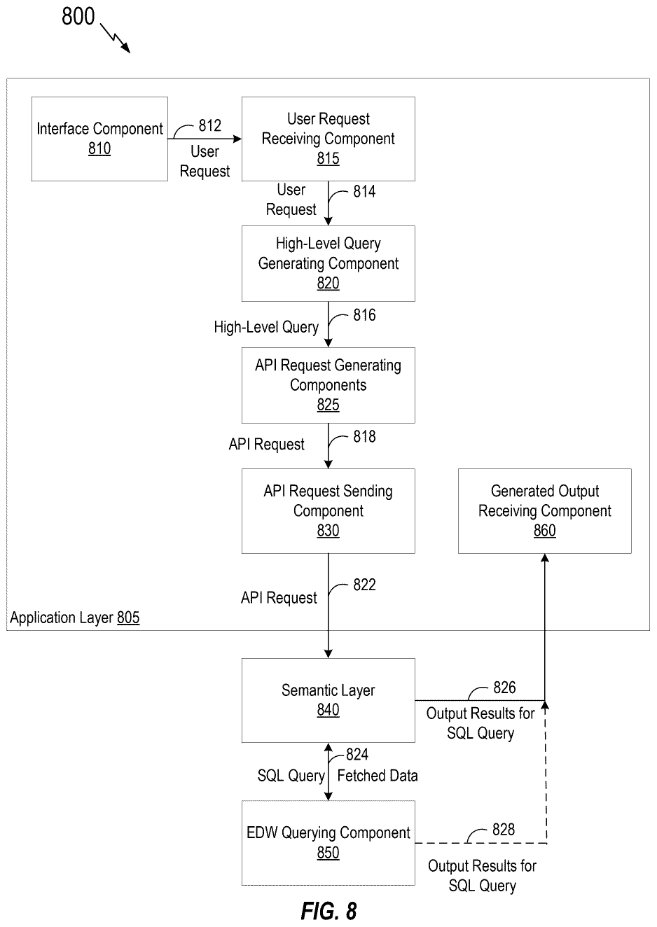

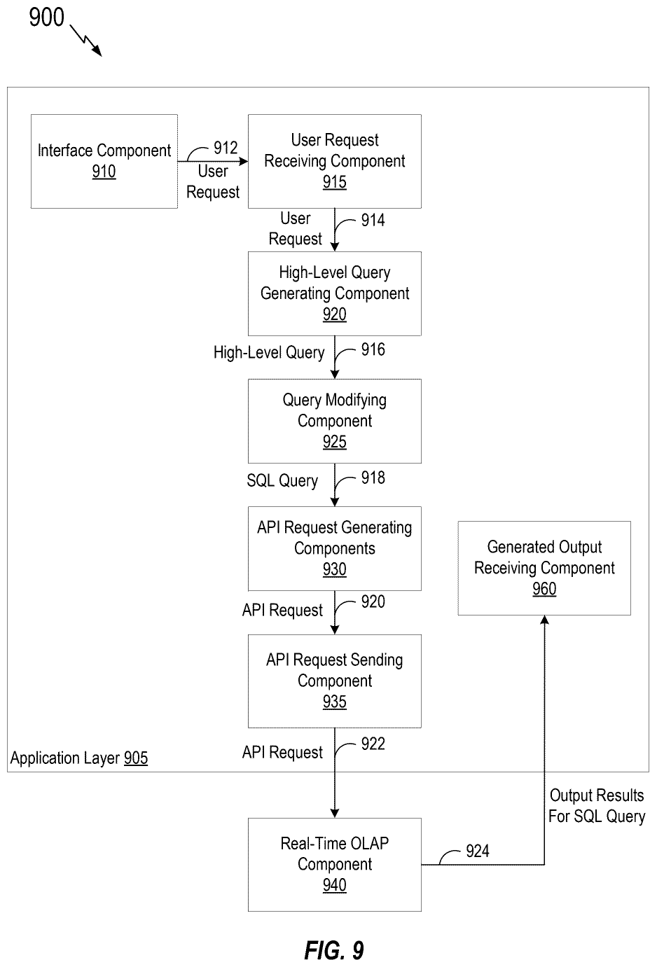

As shown in FIG. 6, semantic layer 610 includes a cube file generating component 612 for generating cube files including data cubes for events received from the one or more digital portals. A cube file is a multi-dimensional data structure that organizes data into a tabular form to facilitate efficient analysis. Cube files generated by the cube file generating component 612 may specify measures, dimensions, joins, and pre-aggregations associated with certain digital portal data (such as digital portal data corresponding to a given event from the digital portal.) Measures may include metrics to be aggregated, such as “sum”, “count”, “average”, etc. Dimensions may include fields by which the data is grouped or filtered. “Joins” may refer to relationships between multiple cube files. “Pre-aggregations” may refer to precomputed summaries of data that can speed up queries by reducing the amount of data processed during execution of a query. In certain aspects, cube file generating component 612 of semantic layer 610 may generate cube.js files using an API component 619 for utilizing an API call to access an open source cube.js framework. In certain aspects, the cube files may be stored within a binary large object (BLOB) storage 620 at regular intervals for long term storage. The generated cube files represent the digital portal data across multiple dimensions, and organize the data to enable more efficient querying and aggregation for facilitating downstream performance of various data analytic functions by data processing systems according to one or more aspects. For example, a query building component 613 of semantic layer 610 may be configured to communicate with a server of a cube.js framework to cause the cube.js framework to validate column names and metrics of one or more cube files associated with a high-level query received from a request of a user of front-end applications 630 (for example via application layer 250 of FIG. 2). The query building component 613 of the semantic layer 610 may then generate an improved query (e.g. an SQL query) based on the cube files and the received high-level query. The improved query may then be sent using an API component 619 to EDW querying components (such as EDW querying components 470 of FIG. 4) to generate results for the improved query by fetching the transformed data (transformed clickstream data) stored in the EDW schemas. Illustrative processes of utilizing the application layer and the semantic layer of data processing systems according to one or more aspects are described in greater detail below in connection with FIGS. 8 and 9.

In certain aspects, semantic layer 610 is configured to generate cube files for each captured new event that occurs within the one or more digital portals. The semantic layer 610 may be further configured to detect, for a received subsequent event, a stored cube file having identical event having a number of additional unique attributes. When additional attributes become part of any existing event, described aspects may automatically ensure the additional attributes become part of the same cube, thereby providing the benefit of keeping the semantic layer 610 in sync with the EDW schema (such as EDW schema 460 with reference to FIG. 4) without manual intervention, and promotes processing event data as soon as it is available such that it may be used for downstream tasks. For example, described aspects may utilize cube file generating component 612 to generate a cube file for a “User Registration” event that stores details related to the event. If additional attributes or information related to the “User Registration” event becomes available at a later time, such as when a user verifies an email address, described aspects may add the additional attributes to the existing cube file for the “User Registration” event.

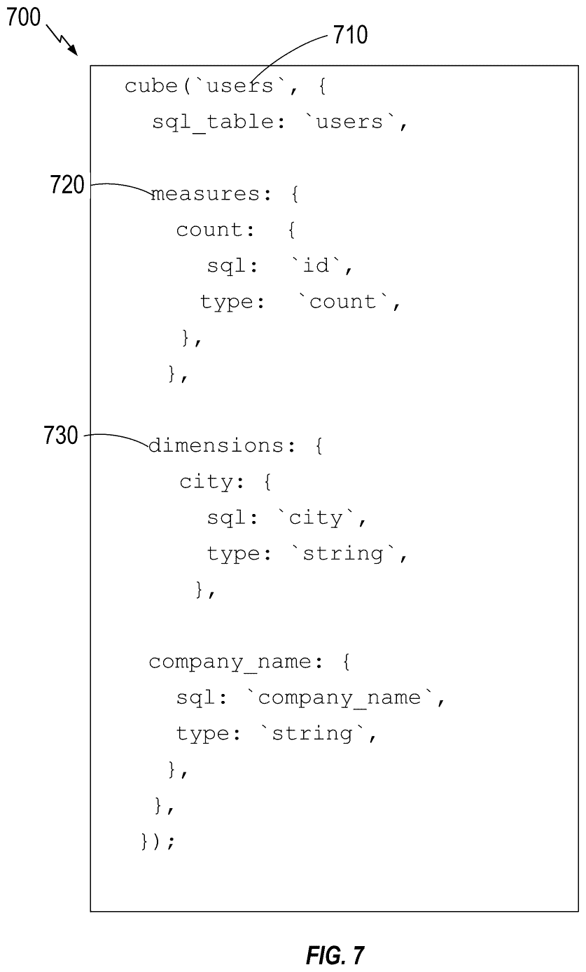

FIG. 7 depicts an illustrative portion of a cube file 700 according to one or more aspects. Cube file 700 includes a cube name 710, cube measures 720, and cube dimensions 730 (e.g. “company name”). The information contained in cube file 700 may be information that is maintained for each received event from the one or more digital portals. Accordingly, when queries are received by the application layer of the data processing system, the cube file may be utilized for generating a more structured query that may be efficiently processed by the EDW querying component (such as EDW querying components 470 of FIG. 4) configured to fetch the data from the EDW schemas for generating and returning query results back to the user of the data processing system.

Returning to FIG. 6, semantic layer 610 further includes a data modeling component 614. In some aspects, data modeling component 614 is configured to create abstraction layers for translating technical schemas into domain-specific terms. In some aspects, data modeling component 614 may be configured to define business logic and metrics, including calculations and aggregations for reports and data analysis. In some aspects, data modeling component 614 may be configured to create dimensional models to facilitate downstream querying. In certain aspects, data modeling component 514 may further be configured to establish relationships and joins, optimize how data is queried and aggregated, enforce data governance and security policies, and provide consistent views of data by standardizing metrics and definitions. In certain other aspects, data modeling component 614 of semantic layer 610 may perform additional functions as may be useful for processing and leverage digital portal data from the one or more digital portals connected to data processing systems according to one or more aspects.

Semantic layer 610 further includes an access control component 616 for enforcing data governance and security policies for the digital portal data processed by data processing systems according to one or more aspects. As an example, access control component 616 may enforce role-based access controls (RBACs), auditable access controls, data masking and anonymization controls, and other data governance policies. As previously described, systems and methods described herein utilize native architecture, such as semantic layer 610 to give organizations employing described aspects greater control over data governance policies. This provides improved flexibility in data management, and improved data security, allowing organizations and users of data processing systems according to one or more aspects to utilize sensitive data that may otherwise be unusable using conventional techniques (as described above.)

Semantic layer 610 further includes a caching component 618 for improving performance and efficiency by improving query performance and reducing load on data warehouses. For example, caching component 618 may cache results of common or computational heavy queries. Caching component 618 may further cache query results so that subsequent identical queries can be served from a cache rather than a database. Caching component 618 may further be configured to perform other suitable techniques for improving performance and efficiency of data processing systems according to one or more aspects.

Semantic layer 610 further includes an API components 619 for managing how applications of the application layer of data processing systems according to one or more aspects interact with the connected digital portal data via APIs. As an example, in certain aspects, the API components 619 of semantic layer 610 enable different applications to interact with the data processing system to query, retrieve, and interact with digital portal data of the one or more digital portals connected to the data processing system. In some aspects, API components 619 may enable the use of different APIs for querying or retrieving of digital portal data for use by front-end applications 630.

FIG. 8 depicts an illustrative process 800 implemented by an application layer (such as application layer 250 of FIG. 2) of a data processing system according to one or more aspects. An application layer 805 of data processing systems according to one or more aspects may be accessed by a user using, for example, an interface component 810 including a web-based interface or a mobile application. The interface may include any suitable dashboard, reporting tool, or analytics platform.

At 812, illustrative process 800 may start with a user request receiving component 815 of application layer 805 receiving, from the interface component 810, a user request. For example, a web-based interface in accordance with described aspects may allow a user to utilize filters and drop downs within the web-based interface to select parameters (e.g. date ranges, specific metrics, or other dimensions associated with digital portal data of a digital portal connected to the data processing system) for generating a corresponding report showing a number of customers who complete a transaction for a specific product. In certain aspects, interface component 810 is be configured to receive user requests from a drag-and-drop interface where a user builds queries visually by dragging metrics and dimensions into specific areas for analysis. In some examples, interface component 810 includes a search box for receiving high-level queries from a user in natural language (e.g. “show me total user visits to landing page X in 2024”), which is then interpreted by the system and converted to a structured query using any suitable known methods.

At 814, the user request is sent to a high-level query generating component 820. At 816, high-level query generating component generates a high-level query based on the received user request. The high-level query is a structured query corresponding to the user request that may be sent to the semantic layer 840. For example, the generated high-level query may be in JavaScript object notation (JSON) format.

At 818, an API request generating component 825 may then generate an API request to send the high-level query (e.g. in JSON format) to an API request sending component 830. At 820, the API request sending component sends the generated API request (based on the generated high-level query) to the semantic layer 840.

At 824, semantic layer 840 then translates the high-level query into an SQL query (for example, using the query building component 613 of FIG. 3) For example, semantic layer 840 may utilize API calls (for example using API component 619 of semantic layer 610 of FIG. 6) to utilize cube.js as a semantic layer for processing, aggregating, and optimizing a received high-level query from application layer 805 to generate a corresponding SQL query for facilitating retrieval or relevant stored data from an EDW schema (such as EDW Schema 460 described above with reference to FIG. 4). In some examples, described aspects may first utilize the caching component of the semantic layer (such as caching component 618 of semantic layer 610 as described above with reference to FIG. 6) to provide available results, thereby reducing compute cost and time investment associated with fetching data from an EDW schema. If results are not available in the caching layer, then described aspects send the SQL query to EDW querying component 850 (such as EDW querying component 470 described above with reference to FIG. 4) to fetch relevant clickstream data from the accessible EDW schemas and generate output corresponding to the user request (e.g. reports, charts, and/or graphs).

At 826, the generated output is sent by the semantic layer 840. The generated output may then be displayed to the user via the interface component 810. In certain aspects, at 828, the EDW querying component 850 may instead fetch the appropriate data for processing the SQL query to output results for sending directly to the generated output receiving component 860.

FIG. 9 depicts an illustrative process 900 implemented by an application layer 905 (such as application layer 250 of FIG. 2) of a data processing system for querying real-time streaming data according to one or more aspects. Certain aspects of application layer 905 of FIG. 9 are the same and perform similar functions to the application layer 805 described above with reference to FIG. 8. For example, interface component 910 may be used to send a user request 912 to a user receiving component 915 using similar means as described above with reference to FIG. 8 At 914, the user request is passed to a high-level query generating component 920 configured to generate a high level query using similar means as described above with reference to FIG. 8. However, in process 900, at 916, the high level query is then passed to a query modifying component 925 provided by the application layer 905. The query modifying component 925 is configured to modify a received high-level query to convert it to a SQL query suitable for processing by the real-time OLAP component 940. At 918, the SQL query generated by query modifying component 925 is then sent to an API request generating component. At 920, API request generating component 930 then generates an API request including the generated SQL query. At 922, an API request sending component 935 then sends the generated API request, including the generated SQL query, to a real-time OLAP component 940 for processing the query. As previously discussed, real-time OLAP component 940 may be configured to process queries relating to continuously real-time streaming data by utilizing reformatted data (such as reformatted data generated and stored by real-time OLAP component 540 of FIG. 5) to generate outputs for the received SQL query. The generated output is then sent by the real-time OLAP component 940 to a generated output receiving component 960. The generated output may then be displayed to the user via the interface component 910 of application layer 905.

Thus, data processing systems according to one or more aspects herein are capable of generating results for diverse digital portal datasets including both real-time streaming data, and long term data stored within EDW schemas.

In certain aspects, the application layer (such as application layers 805 and 905 of FIGS. 8 and 9) of data processing systems according to aspects herein may be configured to allow a user to generate high-level queries for a variety of different tasks. As an example, high-level query generating components (such as high-level query generating component 820 of application layer 805 in FIG. 8) described herein may be configured to allow users to utilize predefined query templates for different tasks performable by leveraging the digital portal data ingested and processed by the data processing system. Examples of different illustrative tasks performable by the application layer of data processing systems according to one or more aspects are described in greater detail below.

In certain aspects, the application layer of the data processing system is configured to generate high-level queries for generating and obtaining different chart types based on event data, cohorts, and user profiles within the ingested and processed digital portal data. In certain aspects, the application layer is configured to permit users to utilize different formulas, compare data over time, and generate custom events and properties for additional insights. For example, the application layer may generate results in response to a user request that includes user-selected aggregate functions applied to one or more user properties or one or more event properties. The user-selected aggregate functions may include, for example, averages, medians, percentiles, min, max, etc.) For example, the application layer may generate results, based on a user-selected aggregate function for reporting an average number of users from a specific country (user property) visiting the digital portal. This enables users of the data processing system to visual trends and compositions within the date processed by data processing system.

In another example, the application layer of the data processing system is configured to further generate high-level queries for generating and obtaining chart types based on how users of the digital portal perform events in a series. As an example, the application layer may generate a high-level query to calculate and display the amount of users associated with the one or more digital portals who convert from one event to another (e.g. adding a product to a cart on a first page and then navigating to a second page to checkout) within a given funnel. As used herein a “funnel” refer to a series of steps or stages that a user of a digital portal goes through to complete a specific goal or action within the digital portal. For example, a funnel may include visiting a landing page, visiting a product page, adding a product to a cart, and checking out. By generating and outputting results displaying the amount of users associated with the one or more digital portals who convert from one event to another, the application layer of the data processing system enables users of the data processing system to determine where users drop off, what segments of users successfully convert, and other insights about the users of the one or more digital portals. In certain aspects, the application layer further allows a user to generate secondary reports for a given funnel or series of events by adjusting an applied time horizons. In other words, the user of the data processing system may generate secondary results (reports, insights, charts, graphs, etc.) by adjusting a predetermined duration of time being considered (e.g. a conversion window) for a given funnel being considered. For example, the user may apply different conversion windows (e.g., 1 day, 30 days, etc.) for a selected step in a funnel, where the conversion window considers the time it takes from a specific previous step, as opposed to the time it takes to arrive at the selected step from a first sequential step in a funnel. This enables users to better understand how long users of the digital portal connected to the data processing system engage with a specific portion (e.g. a link, a web page, etc.) of the one or more digital portals as it relates to a given funnel including one or more steps or events therein.

In another example, the application layer of the data processing system is configured to further generate high-level queries for generating and obtaining reports or chart types depicting the most frequent paths taken by users to or from any event. This enables users to understand sequences in which users of the digital portal perform product actions, indicating sources of drop-offs or unsuccessful behavior.

In yet another example, the application layer of the data processing system is configured to further generate high-level queries for generating and obtaining specialized tables including event data enriched with user properties and demographic attributes of the users that performed the events of the event data. In certain aspects, the user properties may include names, user identifiers, originating country, and other suitable user properties extractable from the processed data from the one or more digital portals.

In another example, the application layer of the data processing system is configured to further generate a dashboard accessible via the interface component (such as the interface component 810 of FIG. 8) including reports for highlighting data and metrics associated with users of the digital portals for simultaneous tracking and viewing. The dashboard may include any reports, charts, insights, or information that may be generated by the application layer. In certain aspects, the application layer is further configured to permit users of the data processing system to share dashboards with another user.

In another example, the application layer of the data processing system is configured to further generate high-level queries for generating and obtaining reports, chart types, or tables by filtering groups of users (sometimes referred to as cohorts of users) who have performed a particular group of events or share common user properties. For example, a generated high-level query may generate and obtain a report showing users from a given country who have accessed a specific web page within the digital portal.

In some aspects, the application layer of the data processing system is configured to allow a user to generate a custom event. As used herein, a custom event refers to a virtual event created by a user of the data processing system by combining one or more existing events. As an example, a user may utilize the application layer of the data processing system to generate a custom event that merges two existing events into a single event, such as a “user signup” event and an “account created” event being merged into a “signup” event. As another example, a user may use create a custom event by employing a filter on another existing event, such as a custom event for “Purchases” filtered by country data to only include data originating from Country=“United States” to only capture purchases made by users within the United States. In certain aspects, the application layer of the data processing system is configured to allow the user to further refine the custom event by applying optional filters, selectable by the user of the data processing system based on a specific set of properties. In some aspects, the application layer of the data processing system may be further configured to allow the user to assign or modify the name of the custom event. This enables users of the data processing system to define and create custom events that suit specific requirements by leveraging the properties and characteristics of existing events, providing increased flexibility and customizability. In some aspects, users generate custom properties by combining existing properties using “case when” structured query language (SQL) commands. “Case when” SQL commands refer to commands that introduce conditional logic into queries, such as by introducing “if-then-else” style operations for evaluating a condition for each row and returning a value based on whether the condition is true or false. The generated custom properties may then be applied for generating various high-level queries associated with different tasks performable by the application layer, including but not limited to the tasks performable by the application layer as described herein.

In some aspects, the application layer of the data processing system is configured to generate and enable users to view a live feed depicting all user properties and event history for a specific user of the digital portal, with a most recent activity appearing at a top portion of the live feed. In certain aspects, the application layer of the data processing system may be further configured to include a search function that allows a user of the data processing system to search the live feed based on a target user's email, a target user's unique identifier or an anonymous identifier assigned to a target user.

It may be understood that the above described functionalities and performable tasks of the application layer of data processing systems according to one or more aspects are merely illustrative. Additional functionalities and performable tasks associated with the application layer, including those based on combinations of the above-described features employable by the data processing system are envisioned.

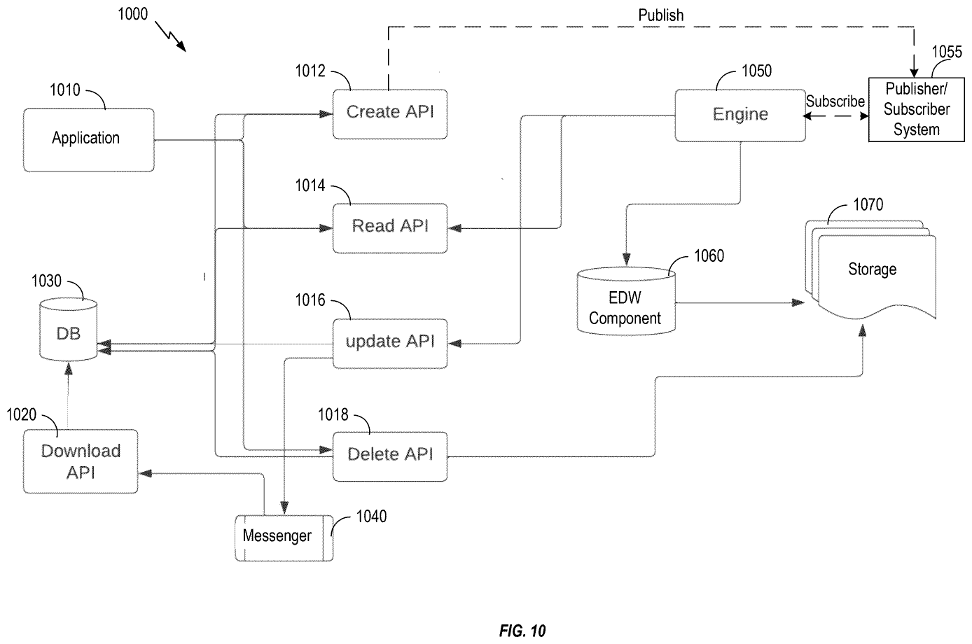

FIG. 10 depicts an illustrative process 1000 implemented by a data processing system according to described aspects for performing bulk exporting of processed data. In certain aspects, the user may request to bulk export an entire dataset from the data processing system. Data processing systems described herein may be configured to perform bulk export functions using a publisher/subscriber model. As an example, the user may request to bulk export an entire dataset of event records using an application 1010. The data processing system then acts as the publisher, pushing the records of the entire dataset to a storage 1070. In certain aspects, storage 1070 is a BLOB storage component. After the entire dataset is stored in the storage 1070, the data processing system sends a notification to the user that the data is ready for download.

As an example, in some aspects, the user makes a selection in application 1010 by clicking an icon or a link to request a bulk export and create a job identifier, causing a corresponding query to be sent and stored in EDW component 1060 as a view. In certain aspects, the data processing system includes a set of APIs to be called during illustrative process 1000. As an example, in certain aspects the set of APIs include a create API 1012 for entering details for the bulk export request into a database 1030 containing, for the entire dataset, records, job identifiers, name of the user, email of the user, metadata or summary of the data to be exported, a reference path or URL to where the exported data is stored in the storage 1070 and other useful information for tracking the lifecycle of requested bulk export jobs. In certain aspects, the set of APIs further include a read API 1014 for reading a pending request from database 1030, and an update API 1016 for entering detailed information related to storage 1070 into database 1030. In certain aspects, the update API 1016 may further be configured to generate a notification to be displayed to the user via a messenger 1040 when the dataset to be exported has been prepared within storage 1070. As an example, update API 1016 may send a notification to a user of messenger 1040 including a link to begin a bulk exporting process. In certain aspects, messenger 1040 includes any suitable application for messaging or displaying notifications to the user. Thereafter, a download API 1020 may be configured to enable the user to download, to a user's system of choice, the entirety of the requested dataset with the received (and selected) link for the requested bulk export. A delete API 1018 may be used to cancel or remove an export request to prevent unnecessary processing or storage usage.

In some examples, an engine 1050 of described aspects may instead subscribe to a publisher/subscribe system 1055. In some examples, publisher/subscriber system 1055 may be an open source Kafka streaming platform. Described aspects may utilize publisher/subscriber system 1055 to enable faster execution of incoming export requests. For example, rather than making an API call using read API 1014, engine 1050 subscribes to publisher/subscriber system 1055 for new export requests. Create API 1012 then publishes any new export requests into publisher/subscriber system 1055 and writes the request data into database 1030. In certain aspects, bulk exporting processes performable by the data processing system include a process for exporting an entire dataset from one or more digital portals connected to the data processing system. In some aspects, the data processing system is configured to perform a process of exporting up to 10,000 records for faster retrieval of subsets of data or records.

### Example Method for Comprehensive Processing of Diverse Digital Portal Data

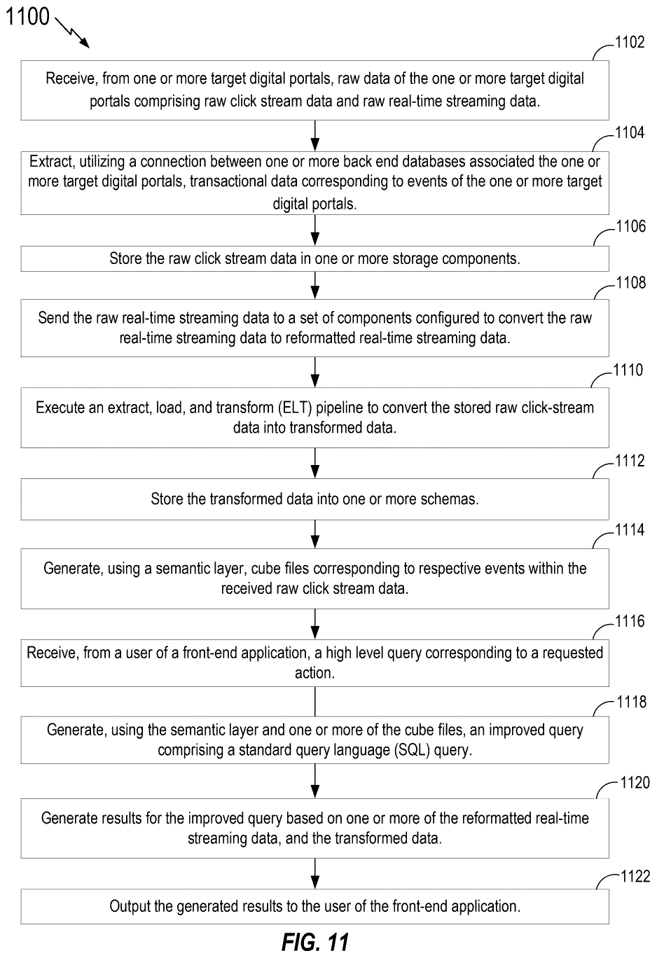

FIG. 11 depicts a flowchart of a method 1100 for comprehensive processing of digital portal data for data analytics according to one or more aspects.

In this example, method 1100 begins at block 1102 with receiving, from one or more target digital portals, raw data of the one or more target digital portals comprising raw clickstream data and raw real-time streaming data. For example, block 1102 may be performed by one or more computing devices, such as computing devices 115 described above with reference to FIG. 1, configured to implement components including, but not limited to, HTTP requesting component 325 and data receiving component 326 of FIG. 3.

Method 1100 proceeds to block 1104 with extracting, utilizing a connection between one or more back end databases associated the one or more target digital portals, transactional data corresponding to events of the one or more target digital portals. For example, block 1104 may be performed by one or more computing devices, such as computing devices 115 described above with reference to FIG. 1, configured to implement components including, but not limited to, data extracting component 327 of FIG. 3

Method 1100 proceeds to block 1106 with storing the raw clickstream data in one or more storage components. For example, block 1106 may be performed by one or more computing devices, such as computing devices 115 described above with reference to FIG. 1, configured to implement components including, but not limited to, data receiving component 326 and storage 321 of FIG. 3.

Method 1100 proceeds to block 1108 with sending the raw real-time streaming data to a set of components configured to convert the raw real-time streaming data to reformatted real-time streaming data. For example, block 1108 may be performed by one or more computing devices, such as computing devices 115 described above with reference to FIG. 1, configured to implement components including, but not limited to, data sending component 415 of FIG. 4.

Method 1100 proceeds to block 1110 with executing an extract, load, transform (ELT) pipeline to convert the stored raw clickstream data into transformed data. For example, block 1110 may be performed by one or more computing devices, such as computing devices 115 described above with reference to FIG. 1, configured to implement components including, but not limited to, second ELT pipeline 450 of FIG. 4.

Method 1100 proceeds to block 1112 with storing the transformed data into one or more schemas. For example, block 1110 may be performed by one or more computing devices, such as computing devices 115 described above with reference to FIG. 1, configured to implement components including, but not limited to second ELT pipeline 450 and EDW Schema 460 of FIG. 4.

Method 1100 proceeds to block 1114 with generating, using a semantic layer, cube files corresponding to respective events within the received raw clickstream data. For example, block 1114 may be performed by one or more computing devices, such as computing devices 115 described above with reference to FIG. 1, configured to implement components including, but not limited to cube file generating component 612 of FIG. 6.

Method 1100 proceeds to block 1116 with receiving, from a user of a front-end application, a high-level query corresponding to a requested action. For example, block 1116 may be performed by one or more computing devices, such as computing devices 115 described above with reference to FIG. 1, configured to implement components including, but not limited to API request sending component 830 and semantic layer 840 of FIG. 8.

Method 1100 proceeds to block 1118 with generating, using the semantic layer and one or more of the cube files, an improved query comprising a structured query language (SQL) query. For example, block 1118 may be performed by one or more computing devices, such as computing devices 115 described above with reference to FIG. 1, configured to implement components including, but not limited to semantic layer 840 of FIG. 8.

Method 1100 proceeds to block 1120 with generating results corresponding to the query based on one or more of the cube files, the reformatted real-time streaming data, and the transformed data. For example, block 1120 may be performed by one or more computing devices, such as computing devices 115 described above with reference to FIG. 1, configured to implement components including, but not limited to EDW querying component 850 and real-time OLAP component 940 of FIGS. 8 and 9 respectively.

Method 1100 proceeds to block 1122 with outputting the generated results to the user of the front-end application. For example, block 1122 may be performed by one or more computing devices, such as computing devices 115 described above with reference to FIG. 1, configured to implement components including, but not limited to generated output receiving component 860 and interface component 810 of FIG. 8.

In certain aspects, method 1100 further includes sending the raw data of the one or more target digital portals to the set of components or to the ELT pipeline based on a data type of the raw data.

In certain aspects, method 1100 further includes storing the transformed data in an operational data store (ODS) schema, extracting the stored transformed data from the ODS schema; and joining the extracted data with secondary tables comprising internal back end data. In certain aspects, storing the transformed data into the one or more schemas further comprises storing the joined extracted data and the secondary tables into an enterprise data warehouse schema.

In certain aspects, method 1100 further includes sending the raw real-time streaming data to a set of components configured to convert the raw real-time streaming data to reformatted real-time streaming data, where the set of components include: a webhook configured to send the raw real-time streaming data downstream; a distributed event streaming platform configured to receive the raw real-time streaming data from the webhook; and stream, using a streaming engine, the raw real-time streaming data; and a real-time distributed Online Analytical Processing (OLAP) component configured to: ingest the streamed raw real-time streaming data; convert the ingested raw real-time streaming data to reformatted real-time streaming data; index the reformatted real-time streaming data; and store the indexed reformatted real-time streaming data for querying.

In certain aspects, method 1100 further includes sending the raw clickstream data in the one or more storage components to a unified analytics engine component; partitioning, using the unified analytics engine component, the raw clickstream data in the one or more storage components into a series of partitions; flattening schemas corresponding to respective events within the raw clickstream data; standardizing column names of the flattened schemas by removing irregularities within the column names; populating a series of relevant attributes associated with the respective events; and creating meta files for the respective events.

In certain aspects, method 1100 further includes storing the cube files into a binary large object storage component.

In certain aspects, method 1100 further includes, in response to receiving a bulk export request from the user, sending, a dataset comprising stored event records to a binary large object storage component; and sending, to the user, a notification including a link to download the dataset.

In certain aspects, method 1100 further includes detecting, for a received subsequent event, a stored cube file comprising an identical event comprising a number of additional attributes less than a predetermined threshold; and editing the stored cube file to include the number of additional attributes.

In certain aspects, the generated results comprise values corresponding to a user-selected aggregate function applied to one or more user properties or one or more event properties. In certain aspects, the generated results are based on calculating a number of users that convert from a previous event to a next subsequent event within a predetermined duration of time.

In certain aspects, method 1100 further includes generating secondary results by adjusting the predetermined duration of time.

Method 1100 thus overcomes the constraints of current techniques that rely upon use of third-party web-based platforms by utilizing native system architecture including an improved sourcing layer configured to utilize direct connections between the sourcing layer and back end databases associated with one or more digital portals. Improved system architecture including staging layers in accordance with described aspects enable ingestion of data with improved fidelity and reduced data loss as compared to the transport mechanisms relied upon by conventional methods, reducing the numbers of HTTP network calls sent for transporting the digital portal data. Described aspects then funnel the digital portal data, depending on a data type, to different components for real-time processing or batch mode processing. Described aspects further provide users of systems described herein with increased control over data governance and security, allowing for ingestion and processing of internal back end data associated with the one or more digital portals. Described aspects provide a number of technical benefits associated with the employed native system architecture for ingesting and processing digital portal data. As an example, fewer HTTP network calls improves web performance (e.g. quick page load times, fewer outgoing tracking calls, etc.) for users interacting with the digital portals. Described aspects further provide the technical benefit of improved accuracy in the transporting of event data from a digital portal, due to reduced loss of event data during data transport, which causes improved accuracy when performing downstream tasks that rely upon the digital portal data ingested and processed by aspects described herein due to utilizing comprehensive digital portal datasets unaffected by data loss of conventional techniques. Described aspects further allow for ingestion and processing of internal backend data, which provides the technical benefit of storing more comprehensive digital portal datasets that include more digital portal data, increasing the accuracy and precision of downstream tasks which utilize the stored comprehensive digital portal datasets.

Note that FIG. 11 is just one example of a method, and other methods including fewer, additional, or alternative operations are possible consistent with this disclosure.

### Example Computing Device for Comprehensive Processing of Diverse Digital Portal Data

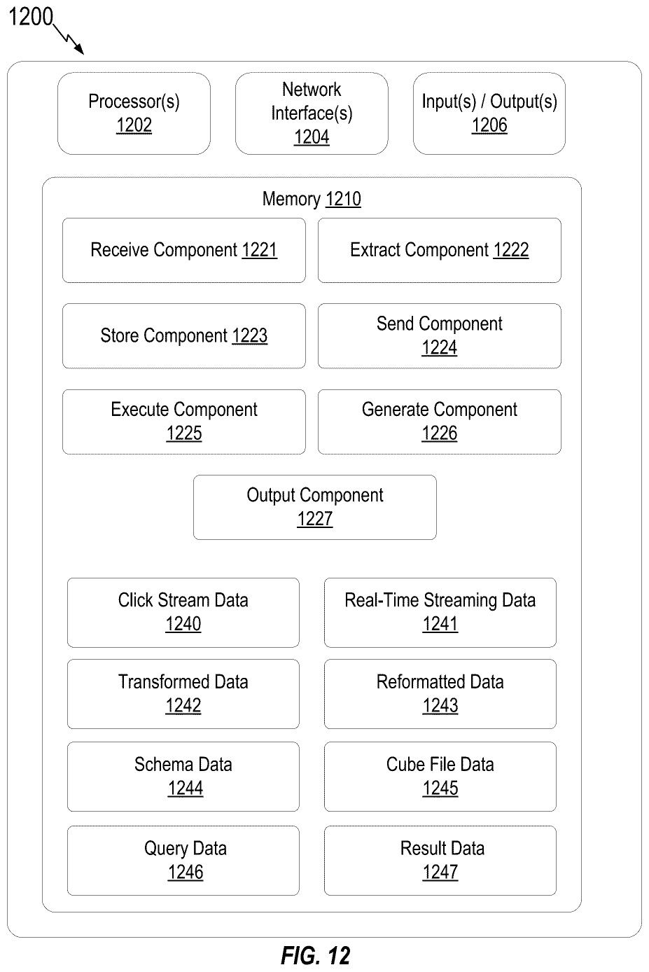

FIG. 12 schematically depicts an example computing device 1200 for enabling a data processing system configured to perform techniques for processing digital portal data according to one or more aspects.

The computing device 1200 includes one or more processors 1202. Generally, processor(s) 1202 may be configured to execute computer-executable instructions (e.g., software code) to perform various functions, as described herein.

The computing device 1200 further includes a network interface(s) 1204, which generally provides data access to any sort of data network, including personal area networks (PANs), local area networks (LANs), wide area networks (WANs), the Internet, and the like.

The computing device 1200 further includes input(s) and output(s) 1206, which generally provide means for providing data to and from the computing device 1200, such as via connection to computing device peripherals, including user interface peripherals.

The computing device 1200 further includes a memory 1210 configured to store various types of components and data.

In this example, memory 1210 includes a receive component 1221, an extract component 1222, a store component 1223, a send component 1224, an execute component 1225, a generate component 1226, and an output component 1227.

Receive component 1221 may be configured to perform processes, for example, corresponding to blocks 1102 and 1116 of the method 1100 depicted and described with reference to FIG. 11.

Extract component 1222 may be configured to perform processes, for example, corresponding to blocks 1104 of the method 1100 depicted and described with reference to FIG. 11.

Store component 1223 may be configured to perform processes, for example, corresponding to blocks 1106 and 1112 of the method 1100 depicted and described with reference to FIG. 11.

Send component 1224 may be configured to perform processes, for example, corresponding to block 1108 of the method 1100 depicted and described with reference to FIG. 11.

Execute component 1225 may be configured to perform processes, for example, corresponding to block 1110 of the method 1100 depicted and described with reference to FIG. 11.

Generate component 1226 may be configured to perform processes, for example, corresponding to blocks 1114 and 1118 of the method 1100 depicted and described with reference to FIG. 11.

Output component 1227 may be configured to perform processes, for example, corresponding to block 1120 of the method 1100 depicted and described with reference to FIG. 11.

In this example, memory 1210 also includes clickstream data 1240, real-time streaming data 1241, transformed data 1242, reformatted data 1243, schema data 1244, cube file data 1245, query data 1246, and result data 1247.

The computing device 1200 may be implemented in various ways. For example, the computing device 1200 may be implemented within on-site, remote, or cloud-based computing devices.

The computing device 1200 is just one example, and other configurations are possible. For example, in alternative aspects, features described with respect to the computing device 1200 may be omitted, added, or substituted for alternative aspects

### EXAMPLE CLAUSES

Implementation examples are described in the following numbered clauses:

Clause 1: A method, including: receiving, from one or more target digital portals, raw data of the one or more target digital portals comprising raw clickstream data and raw real-time streaming data; extracting, utilizing a connection with one or more back end databases associated the one or more target digital portals, transactional data corresponding to events of the one or more target digital portals; storing the raw clickstream data in one or more storage components; sending the raw real-time streaming data to a set of components configured to convert the raw real-time streaming data to reformatted real-time streaming data; executing an extract, load, transform (ELT) pipeline to convert the stored raw clickstream data into transformed data; storing the transformed data into one or more schemas; generating, using a semantic layer, cube files corresponding to respective events within the received raw clickstream data; receiving, from a user of a front-end application, a query corresponding to a requested action; generating, using the semantic layer and one or more of the cube files, an improved query comprising a structured query language (SQL) query; generating results for the improved query based on one or more of the reformatted real-time streaming data and the transformed data; and outputting the generated results to the user of the front-end application.

Clause 2: The method of Clause 1, wherein sending the raw data of the one or more target digital portals to the set of components or to the ELT pipeline is based on a data type of the raw data.

Clause 3: The method of Clause 2, wherein executing the ELT pipeline to convert the raw data from the received data into the transformed data, and storing the transformed data into one or more schemas further comprises: storing the transformed data in an operational data store (ODS) schema; extracting the stored transformed data from the ODS schema; and joining the extracted data with secondary tables comprising internal back end data.

Clause 4: The method of any of Clauses 1-3, wherein storing the transformed data into the one or more schemas further comprises storing the joined extracted data and the secondary tables into an enterprise data warehouse schema.

Clause 5: The method of any of Clauses 1-4, wherein the set of components include: a webhook configured to send the raw real-time streaming data downstream; a distributed event streaming platform configured to: receive the raw real-time streaming data from the webhook; and stream, using a streaming engine, the raw real-time streaming data; and a real-time distributed Online Analytical Processing (OLAP) component configured to: ingest the streamed raw real-time streaming data; convert the ingested raw real-time streaming data to reformatted real-time streaming data; index the reformatted real-time streaming data; and store the indexed reformatted real-time streaming data for querying.

Clause 6: The method of any of Clauses 1-5, further including sending the raw clickstream data in the one or more storage components to a unified analytics engine component; partitioning, using the unified analytics engine component, the raw clickstream data in the one or more storage components into a series of partitions; flattening schemas corresponding to respective events within the raw clickstream data; standardizing column names of the flattened schemas by removing irregularities within the column names; populating a series of relevant attributes associated with the respective events; and creating meta files for the respective events.

Clause 7: The method of any of Clauses 1-6, further including storing the cube files into a binary large object storage component.

Clause 8: The method of any of Clauses 1-7, further including, in response to receiving a bulk export request from the user, sending, a dataset comprising stored event records to a binary large object storage component; and sending, to the user, a notification including a link to download the dataset.

Clause 9: The method of any of Clauses 1-8, wherein generating, using the semantic layer, the cube files corresponding to the respective events within the received raw data further includes: detecting, for an existing event, an additional attribute associated with the existing event; and adding the additional attribute to an existing cube file corresponding to the existing event.

Clause 10: The method of any Clauses 1-9, wherein the generated results comprise values corresponding to a user-selected aggregate function applied to one or more user properties or one or more event properties.

Clause 11: The method of any of Clauses 1-10, wherein the generated results are based on calculating a number of users that convert from a previous event to a next subsequent event within a predetermined duration of time.

Clause 12: The method of any of Clauses 1-11, further including generating secondary results by adjusting the predetermined duration of time.

Clause 14: A method including, receiving, from one or more target digital portals, raw data of the one or more target digital portals comprising raw clickstream data and raw real-time streaming data; extracting, utilizing a connection with one or more back end databases associated the one or more target digital portals, transactional data corresponding to events of the one or more target digital portals; storing the raw clickstream data in one or more storage components; sending the raw real-time streaming data to a set of components configured to convert the raw real-time streaming data to reformatted real-time streaming data; executing an extract, load, transform (ELT) pipeline to convert the stored raw clickstream data into transformed data; storing the transformed data into one or more schemas; and generating, using a semantic layer, cube files corresponding to respective events within the received raw clickstream data.

Clause 15: A processing system, comprising: one or more memories comprising computer-executable instructions; and one or more processors configured to execute the computer-executable instructions and cause the processing system to perform a method in accordance with any one of Clauses 1-14.

Clause 16: A processing system, comprising means for performing a method in accordance with any one of Clauses 1-14.

Clause 17: A non-transitory computer-readable medium comprising computer-executable instructions that, when executed by one or more processors of a processing system, cause the processing system to perform a method in accordance with any one of Clauses 1-14.

Clause 18: A computer program product embodied on a computer-readable storage medium comprising code for performing a method in accordance with any one of Clauses 1-14.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). Reference to an element in the singular is not intended to mean only one unless specifically so stated, but rather “one or more.” For example, reference to an element (e.g., “a processor,” “a memory,” etc.), unless otherwise specifically stated, should be understood to refer to one or more elements (e.g., “one or more processors,” “one or more memories,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method, comprising:
receiving, from one or more target digital portals, raw data of the one or more target digital portals comprising raw clickstream data and raw real-time streaming data;
extracting, utilizing a connection with one or more back end databases associated the one or more target digital portals, transactional data corresponding to events of the one or more target digital portals;
storing the raw clickstream data in one or more storage components;
sending the raw real-time streaming data to a set of components configured to convert the raw real-time streaming data to reformatted real-time streaming data;
executing an extract, load, transform (ELT) pipeline to convert the stored raw clickstream data into transformed data;
storing the transformed data into one or more schemas;
generating, using a semantic layer, cube files corresponding to respective events within the raw clickstream data;
receiving, from a user of a front-end application, a query corresponding to a requested action
generating, using the semantic layer and one or more of the cube files, an improved query comprising a structured query language (SQL) query;
generating results for the improved query based on one or more the reformatted real-time streaming data and the transformed data; and
outputting the generated results to the user of the front-end application.

2. The method of claim 1, wherein sending the raw data of the one or more target digital portals to the set of components or to the ELT pipeline is based on a data type of the raw data.

3. The method of claim 1, wherein executing the ELT pipeline to convert the stored raw clickstream data into the transformed data, and storing the transformed data into one or more schemas further comprises:
storing the transformed data in an operational data store (ODS) schema;
extracting the stored transformed data from the ODS schema; and
joining the extracted transformed data with secondary tables comprising internal back end data.

4. The method of claim 3, wherein storing the transformed data into the one or more schemas further comprises storing the joined extracted data and the secondary tables into an enterprise data warehouse schema.

5. The method of claim 1, wherein the set of components comprise:
a webhook configured to send the raw real-time streaming data downstream;
a distributed event streaming platform configured to:
receive the raw real-time streaming data from the webhook; and
stream, using a streaming engine, the raw real-time streaming data; and
a real-time distributed Online Analytical Processing (OLAP) component configured to:
ingest the streamed raw real-time streaming data;
convert the ingested raw real-time streaming data to reformatted real-time streaming data;
index the reformatted real-time streaming data; and
store the indexed reformatted real-time streaming data for querying.

6. The method of claim 1, further comprising:
sending the raw clickstream data in the one or more storage components to a unified analytics engine component;
partitioning, using the unified analytics engine component, the raw clickstream data in the one or more storage components into a series of partitions;
flattening schemas corresponding to the respective events within the raw clickstream data;
standardizing column names of the flattened schemas by removing irregularities within the column names;
populating a series of relevant attributes associated with the respective events; and
creating meta files for the respective events.

7. The method of claim 1, further comprising:
storing the cube files into a binary large object storage component.

8. The method of claim 1, further comprising:
in response to receiving a bulk export request from the user, sending, a dataset comprising stored event records to a binary large object storage component; and
sending, to the user, a notification including a link to download the dataset.

9. The method of claim 1, wherein generating, using the semantic layer, the cube files corresponding to the respective events within the received raw data further comprises:
detecting, for an existing event, an additional attribute associated with the existing event; and
adding the additional attribute to an existing cube file corresponding to the existing event.

10. The method of claim 1, wherein the generated results comprise values corresponding to a user-selected aggregate function applied to one or more user properties or one or more event properties.

11. The method of claim 1, wherein the generated results are based on calculating a number of users that convert from a previous event to a next subsequent event within a predetermined duration of time.

12. The method of claim 11, further comprising:
generating secondary results by adjusting the predetermined duration of time.

13. A processing system, comprising:
one or more memories comprising computer-executable instructions; and
one or more processors configured to execute the computer-executable instructions causing the processing system to:
receive, from one or more target digital portals, raw data of the one or more target digital portals comprising raw clickstream data and raw real-time streaming data;
extract, utilizing a connection with one or more back end databases associated the one or more target digital portals, transactional data corresponding to events of the one or more target digital portals;
store the raw clickstream data in one or more storage components;
send the raw real-time streaming data to a set of components configured to convert the raw real-time streaming data to reformatted real-time streaming data;
execute an extract, load, and transform (ELT) pipeline to convert the stored raw clickstream data into transformed data;
store the transformed data into one or more schemas;
generate, using a semantic layer, cube files corresponding to respective events within the raw clickstream data;
receive, from a user of a front-end application, a query corresponding to a requested action;
generate, using the semantic layer and one or more of the cube files, an improved query comprising a structured query language (SQL) query;
generate results for the improved query based on one or more of the reformatted real-time streaming data and the transformed data; and
output the generated results to the user of the front-end application.

14. The processing system of claim 13, wherein to execute the ELT pipeline to convert the stored raw clickstream data into the transformed data, and storing the transformed data into the one or more schemas, the one or more processors are further configured to cause the processing system to:
store the transformed data in an operational data store (ODS) schema;
extract the stored transformed data from the ODS schema; and
join the extracted transformed data with secondary tables comprising internal back end data.

15. The processing system of claim 14, wherein to store the transformed data into the one or more schemas, the one or more processors are further configured to cause the processing system to:
store the joined extracted data and the secondary tables into an enterprise data warehouse schema.

16. The processing system of claim 13, wherein the set of components comprises:
a webhook configured to send the raw real-time streaming data downstream;
a distributed event streaming platform configured to:
receive the raw real-time streaming data from the webhook; and
stream, using a streaming engine, the raw real-time streaming data; and
a real-time distributed Online Analytical Processing (OLAP) component configured to:
ingest the streamed raw real-time streaming data;
convert the ingested raw real-time streaming data to reformatted real-time streaming data
index the reformatted real-time streaming data; and
store the indexed reformatted real-time streaming data for querying.

17. The processing system of claim 13, wherein the one or more processors are further configured to cause the processing system to:
send the raw clickstream data in the one or more storage components to a unified analytics engine component;
partition, using the unified analytics engine component, the raw clickstream data in the one or more storage components into a series of partitions;
flatten schemas corresponding to the respective events within the raw clickstream data;
standardize column names of the flattened schemas by removing irregularities within the column names;
populate a series of relevant attributes associated with the respective events; and
create meta files for the respective events.

18. The processing system of claim 13, wherein the one or more processors are further configured to cause the processing system to:
in response to receiving a bulk export request from the user, send, a dataset comprising stored event records to a binary large object storage component; and
send, to the user, a notification including a link to download the dataset.

19. The processing system of claim 13, wherein to generate, using the semantic layer, the cube files corresponding to the respective events within the received raw data, the one or more processors are further configured to cause the processing system to:
detect, for an existing event, an additional attribute associated with the existing event; and
add the additional attribute to an existing cube file corresponding to the existing event.

20. A method comprising:
receiving, from one or more target digital portals, raw data of the one or more target digital portals comprising raw clickstream data and raw real-time streaming data;
extracting, utilizing a connection with one or more back end databases associated the one or more target digital portals, transactional data corresponding to events of the one or more target digital portals;
storing the raw clickstream data in one or more storage components;
sending the raw real-time streaming data to a set of components configured to convert the raw real-time streaming data to reformatted real-time streaming data;
executing an extract, load, transform (ELT) pipeline to convert the stored raw clickstream data into transformed data;
storing the transformed data into one or more schemas; and
generating, using a semantic layer, cube files corresponding to respective events within the raw clickstream data.
